(19) United States
(12) Patent Application Publication
(10) Pub. No.: US 2018/0248168 A1
(43) Pub. Date: Aug. 30, 2018

(54) ELECTROCHEMICAL DEVICE

(71) Applicant: TAIYO YUDEN CO., LTD., Tokyo (JP)

(72) Inventors: Katsunori YOKOSHIMA, Takasaki-shi (JP); Koji KANO, Takasaki-shi (JP)

(21) Appl. No.: 15/902,873

(22) Filed: Feb. 22, 2018

(30) Foreign Application Priority Data
Feb. 27, 2017 (JP) 2017-035431

(51) Int. Cl. H01M 4/134; H01M 10/0525; H01M 10/04; H01G 11/06; H01G 11/50

(52) U.S. Cl. CPC H01M 4/134; H01M 10/0525; H01M 2004/028; H01G 11/06; H01G 11/50; H01M 10/0459

(57) ABSTRACT

An electrochemical device includes multiple electrode bodies and electrolyte. Each electrode body includes: an electrode unit constituted by positive electrodes and negative electrodes that are stacked together alternately with separators in between; a first lithium ion pre-doping supply source which includes a first current collector being a metal foil having no through holes; and a second lithium ion pre-doping supply source which sandwiches the electrode unit together with the first lithium ion supply source, and which includes a second current collector being a metal foil having no though holes. The multiple electrode bodies are stacked in a manner attaching the first current collector of one electrode body to the second current collector of another electrode body. The negative electrodes provided in each electrode unit are pre-doped with lithium ions derived from the first lithium ion pre-doping supply source and the second lithium ion pre-doping supply source.

### BACKGROUND

### Field of the Invention

The present invention relates to an electrochemical device constituted by multiple electrode units.

### Description of the Related Art

Large-capacitance capacitors are finding their way into energy regeneration, load leveling, and other fields that require repeated charging and discharging at high power. Among large-capacitance capacitors, electrical double-layer capacitors have heretofore enjoyed wide popularity; in recent years, however, use of lithium ion capacitors offering high energy density is being studied.

Lithium ion capacitors require pre-doping, which is a process of doping lithium ions into the negative electrode beforehand, and to use a lithium ion capacitor stably for a long period of time, it is important to uniformly pre-dope its negative electrode.

Here, lithium ion pre-doping is carried out by immersing metal lithium which is electrically connected to the negative electrode, in electrolyte. Since lithium ions move through the electrolyte to reach the negative electrode, the state of pre-doping is affected by the position relationship of the negative electrode and the lithium ion supply source.

For example, Patent Literature 1 (which is equivalent to U.S. Pat. No. 7,733,629, each disclosure of which is incorporated herein by reference in its entirety, particularly the definitions of terms and phrases and the structures which are relevant to but not specified in the present disclosure) discloses a constitution where lithium ion supply sources are placed in between, and at the outermost parts of, the multiple electrode units that constitute a cell, to supply lithium ions to the negative electrode.

### BACKGROUND ART LITERATURES

[Patent Literature 1] International Patent Laid-open No. 2006/112068

### SUMMARY

However, the constitution described in Patent Literature 1 allows lithium ions to move easily in between the multiple electrode units, which means that the doping quantity of lithium ions may vary among the electrode units due to the effect of gravity, etc.

In light of the aforementioned situation, an object of the present invention is to provide an electrochemical device that ensures excellent productivity and permits uniform pre-doping of the negative electrode.

Any discussion of problems and solutions involved in the related art has been included in this disclosure solely for the purposes of providing a context for the present invention, and should not be taken as an admission that any or all of the discussion were known at the time the invention was made.

To achieve the aforementioned object, the electrochemical device pertaining to an embodiment of the present invention comprises multiple electrode bodies and electrolyte.

The electrode bodies each comprise: an electrode unit constituted by positive electrodes and negative electrodes that are stacked together alternately with separators in between; a first lithium ion supply source which is placed in a manner adjoining the electrode unit, and which comprises a first current collector being a metal foil having a first principal face on the electrode unit side and a second principal face on the opposite side of the first principal face; and a second lithium ion supply source which is placed in a manner adjoining the electrode unit while also sandwiching the electrode unit together with the first lithium ion supply source, and which comprises a second current collector being a metal foil having a third principal face on the electrode unit side and a fourth principal face on the opposite side of the third principal face.

In the electrolyte, the multiple electrode bodies are immersed.

The multiple electrode bodies are placed in such a way that, between a pair of adjoining electrode bodies, the second principal face adjoins the fourth principal face, and the negative electrodes provided in the electrode unit are pre-doped with lithium ions from a first metal lithium attached on the first principal face and a second metal lithium attached on the third principal face.

According to this constitution, virtually the entire quantity of the lithium ions released from the first lithium ion supply source and second lithium ion supply source reach the electrode unit sandwiched between the two lithium ion supply sources, and is doped into the negative electrodes. This is because a current collector being a metal foil exists between each of the two lithium ion supply sources and the electrode body adjoining it, and this current collector suppresses migration of lithium ions between the adjoining electrode units. This makes the doping quantity of lithium ions roughly equal among the electrode bodies, and consequently the long-term stability of the electrochemical device can be improved.

The positive electrodes provided in the electrode unit may each comprise a positive-electrode collector being a porous metal film, as well as positive-electrode active material layers that contain a positive-electrode active material and are stacked on both the top face and bottom face of the positive-electrode collector, while the negative electrodes provided in the electrode unit may each comprise a negative-electrode collector being a porous metal film, as well as negative-electrode active material layers that contain a negative-electrode active material and are stacked on both the top face and bottom face of the negative-electrode collector.

According to this constitution, the lithium ions released from the first lithium ion supply source and second lithium ion supply source can move in the electrode unit without being obstructed by the positive electrodes, negative electrodes, and separators, which makes it possible to achieve a uniform doping quantity of lithium ions throughout the electrode unit.

The electrode units provided in the multiple electrode bodies may have the same thickness, respectively.

According to this constitution, electrode units having the same structure can be used as a first electrode unit, a second electrode unit, and a third electrode unit, while achieving a uniform doping quantity of lithium ions in each electrode unit.

The electrochemical device may be a lithium ion capacitor.

As described above, an electrochemical device that ensures excellent productivity and permits uniform pre-doping of the negative electrode can be provided according to the present invention.

For purposes of summarizing aspects of the invention and the advantages achieved over the related art, certain objects and advantages of the invention are described in this disclosure. Of course, it is to be understood that not necessarily all such objects or advantages may be achieved in accordance with any particular embodiment of the invention. Thus, for example, those skilled in the art will recognize that the invention may be embodied or carried out in a manner that achieves or optimizes one advantage or group of advantages as taught herein without necessarily achieving other objects or advantages as may be taught or suggested herein.

Further aspects, features and advantages of this invention will become apparent from the detailed description which follows.

### BRIEF DESCRIPTION OF THE DRAWINGS

These and other features of this invention will now be described with reference to the drawings of preferred embodiments which are intended to illustrate and not to limit the invention. The drawings are greatly simplified for illustrative purposes and are not necessarily to scale.

FIG. 1 is a schematic perspective view of the electrochemical device pertaining to an embodiment of the present invention.

FIG. 2 is a schematic cross-sectional view of the same electrochemical device (prior to pre-doping).

FIG. 3 is a schematic cross-sectional view of an electrode body provided in the same electrochemical device.

FIG. 4 is a schematic enlarged view of the electrode unit constituting an electrode body provided in the same electrochemical device (prior to pre-doping), wherein a middle part is omitted for illustrative purposes, indicated by wavy broken lines which do not represent a part of the structure.

FIG. 5 is a schematic view of an electrode body provided in the same electrochemical device (prior to pre-doping), wherein a middle part is omitted for illustrative purposes, indicated by wavy broken lines which do not represent a part of the structure.

FIG. 6 is a schematic view showing a mode of lithium ion pre-doping in the same electrochemical device.

FIG. 7 is a table showing the SOCs of the pre-doped negative electrodes provided in the electrode bodies of the electrochemical devices pertaining to an example, and a comparative example, of the present invention.

### DESCRIPTION OF THE SYMBOLS

101—Electrode body

102—Covering film

103—Positive-electrode terminal

104—Negative-electrode terminal

105—Electric storage element

111—Electrode unit

112—First lithium ion supply source

113—Second lithium ion supply source

120—Positive electrode

121—Positive-electrode collector

122—Positive-electrode active material layer

130—Negative electrode

131—Negative-electrode collector

132—Negative-electrode active material layer

140—Separator

151, 161—Lithium collector

152, 162—Metal lithium

### DETAILED DESCRIPTION OF EMBODIMENTS

The electrochemical device pertaining to this embodiment is explained.

[Structure of Electrochemical Device]

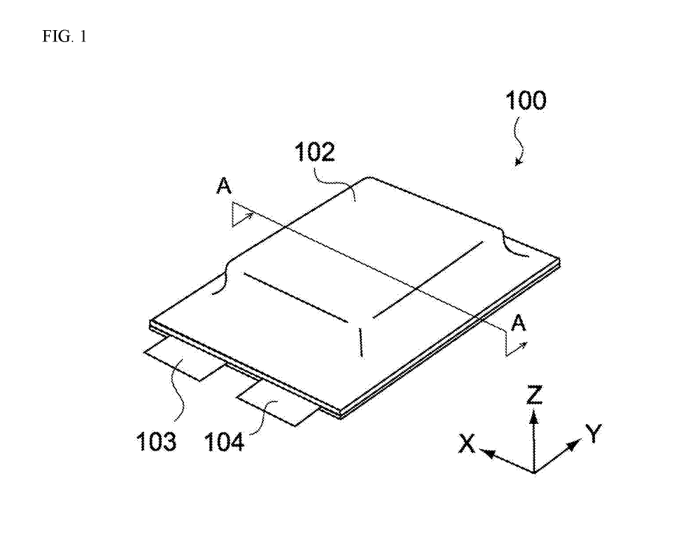

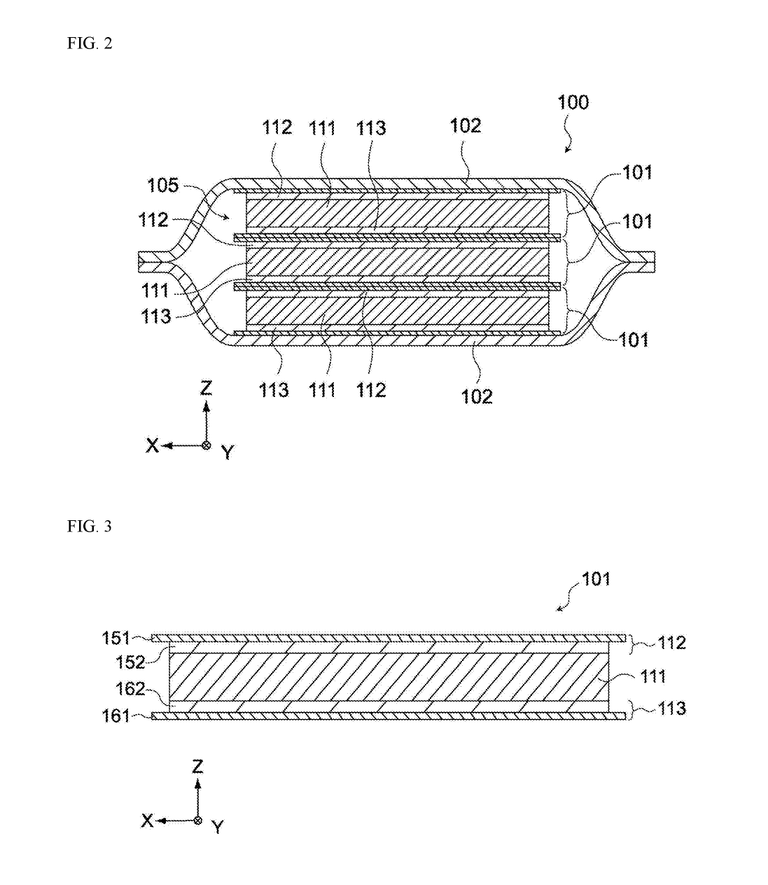

FIG. 1 a perspective view of an electrochemical device 100 pertaining to this embodiment, while FIG. 2 is a cross-sectional view of the electrochemical device 100. FIG. 2 is a cross-sectional view of FIG. 1 along line A-A.

The electrochemical device 100 is an electrochemical device that requires lithium ion pre-doping, and it may be a lithium ion capacitor. Or, the electrochemical device 100 may be a lithium ion battery or other electrochemical device that requires lithium ion pre-doping. In the following explanations, the electrochemical device 100 is a lithium ion capacitor.

As shown in FIGS. 1 and 2, the electrochemical device 100 comprises three electrode bodies 101, a covering film 102, a positive-electrode terminal 103, and a negative-electrode terminal 104. The laminate of the three electrode bodies 101 is hereinafter referred to as “electric storage element 105.”

FIG. 3 is a schematic view of the electrode body 101. As shown in this figure, the electrode body 101 comprises an electrode unit 111, a first lithium ion supply source 112, and a second lithium ion supply source 113. The electrode unit 111 is sandwiched between the first lithium ion supply source 112 and the second lithium ion supply source 113.

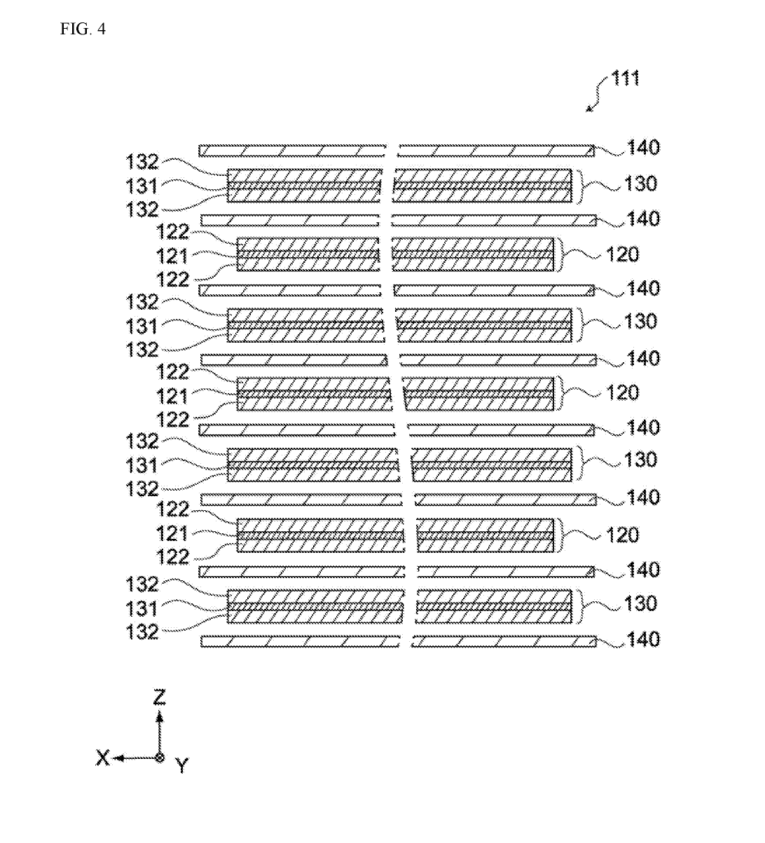

FIG. 4 is a schematic view of the electrode unit 111. As shown in this figure, the electrode unit 111 comprises positive electrodes 120, negative electrodes 130, and separators 140.

The positive electrode 120 comprises a positive-electrode collector 121 and positive-electrode active material layers 122. The positive-electrode collector 121 is a porous metal foil, such as an aluminum foil, for example, in which many through holes have been formed. The thickness of the positive-electrode collector 121 is 0.03 mm, for example. The positive-electrode collector 121 is electrically connected to the positive-electrode terminal 103 either directly or via a wiring which is not illustrated.

The positive-electrode active material layer 122 is formed on both the top face and bottom face of the positive-electrode collector 121. The positive-electrode active material layer 122 may be a mixture of a positive-electrode active material with a binder resin, and it may further contain a conductive auxiliary agent. The positive-electrode active material is a material capable of adsorbing the lithium ions and anions in the electrolyte, such as active carbon or polyacene carbide, for example.

The binder resin is a synthetic resin that joins the positive-electrode active material, for which styrene butadiene rubber, polyethylene, polypropylene, aromatic polyamide, carboxy methyl cellulose, fluororubber, polyvinylidene fluoride, isoprene rubber, butadiene rubber, ethylene propylene rubber, etc., may be used, for example.

The conductive auxiliary agent comprises grains formed by a conductive material, and improves the conductivity between the molecules of positive-electrode active material. The conductive auxiliary agent is graphite, carbon black, or other carbon material, for example. Any one of the foregoing may be used alone, or two or more may be mixed together. It should be noted that the conductive auxiliary agent may also be a metal material, conductive polymer, or other material so long as it has conductive property.

The negative electrode 130 comprises a negative-electrode collector 131 and negative-electrode active material layers 132. The negative-electrode collector 131 is a porous metal foil, such as a copper foil, for example, in which many through holes have been formed. The thickness of the negative-electrode collector 131 is 0.015 mm, for example. The negative-electrode collector 131 is electrically connected to the negative-electrode terminal 104 either directly or via a wiring which is not illustrated.

The negative-electrode active material layer 132 is formed on both the top face and bottom face of the negative-electrode collector 131. The negative-electrode active material layer 132 may be a mixture of a negative-electrode active material with a binder resin, and it may further contain a conductive auxiliary agent. The negative-electrode active material is a material capable of occluding the lithium ions in the electrolyte, such as non-graphitizable carbon (hard carbon), graphite, soft carbon or other carbon material, or Si, SiO, or other alloy material, or a composite material made therefrom.

The binder resin is a synthetic resin that joins the negative-electrode active material, for which styrene butadiene rubber, polyethylene, polypropylene, aromatic polyamide, carboxy methyl cellulose, fluororubber, polyvinylidene fluoride, isoprene rubber, butadiene rubber, ethylene propylene rubber, etc., may be used, for example.

The conductive auxiliary agent comprises grains formed by a conductive material, and improves the conductivity between the molecules of negative-electrode active material. The conductive auxiliary agent is graphite, carbon black, or other carbon material, for example. Any one of the foregoing may be used alone, or two or more may be mixed together. It should be noted that the conductive auxiliary agent may also be a metal material, conductive polymer, or other material so long as it has conductive property.

The separator 140 separates the positive electrode 120 and the negative electrode 130, and lets the ions contained in the electrolyte pass through. The separator 140 may be a woven fabric, non-woven fabric, synthetic microporous resin membrane, etc., whose primary ingredient is olefin resin, for example.

The positive electrodes 120, negative electrodes 130, and separators 140 are stacked together in such a way that the positive electrodes 120 and the negative electrodes 130 are stacked together alternately with the separators 140 in between, and that the lowermost layer and the uppermost layer, excluding the separators 140, are constituted by negative electrodes 130, as shown in FIG. 4. The number of positive electrode 120 layers and that of negative electrode 130 layers are not limited in any way and, for example, there may be nine positive electrode 120 layers and ten negative electrode 130 layers, or the like.

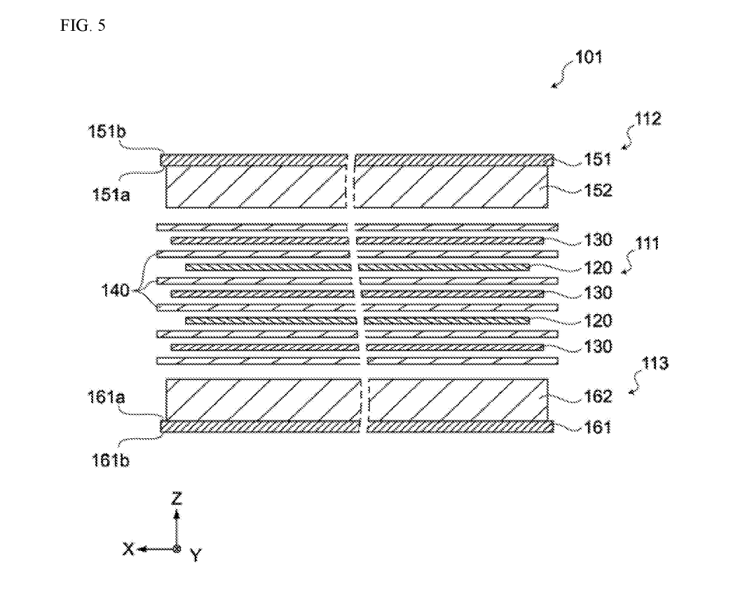

The first lithium ion supply source 112 is placed in a manner adjoining the electrode unit 111 and supplies lithium ions to the negative electrodes 130 in the electrode unit 111. FIG. 5 is an enlarged view of the electrode body 101. As shown in this figure, the first lithium ion supply source 112 comprises a lithium collector 151 and metal lithium 152.

The lithium collector 151 is a metal foil, such as a copper foil, for example, which is electrolyte-impermeable (e.g., having no through holes through which an electrolyte can pass or flow). The lithium collector 151 is electrically connected to the negative-electrode collectors 131 in the electrode unit 111 either directly or via the negative-electrode terminal 104.

As shown in FIG. 5, the principal faces of the lithium collector 151 include a first principal face 151a corresponding to the face on the electrode unit 111 side, and a second principal face 151b corresponding to the face on the opposite side.

The metal lithium 152 is attached on the first principal face 151a by means of pressure bonding, etc. Preferably the metal lithium 152 has an even thickness across the entire surface of the first principal face 151a.

The second lithium ion supply source 113 is placed in a manner adjoining the side of the electrode unit 111 opposite the first lithium ion supply source 112, and sandwiches the electrode unit 111 with the first lithium ion supply source 112. The second lithium ion supply source 113 supplies lithium ions to the negative electrodes 130 in the electrode unit 111. As shown in FIG. 5, the second lithium ion supply source 113 comprises a lithium collector 161 and metal lithium 162.

The lithium collector 161 is a metal foil, such as a copper foil, for example, which is electrolyte-impermeable (e.g., having no through holes through which an electrolyte can pass or flow). The lithium collector 161 is electrically connected to the negative-electrode collectors 131 in the electrode unit 111, either directly or via the negative-electrode terminal 104.

As shown in FIG. 5, the principal faces of the lithium collector 161 include a third principal face 161a corresponding to the face on the electrode unit 111 side, and a fourth principal face 161b corresponding to the face on the opposite side.

The metal lithium 162 is attached on the third principal face 161a by means of pressure bonding, etc. Preferably the metal lithium 162 has an even thickness across the entire surface of the third principal face 161a.

The electrode body 101 has the aforementioned constitution. The multiple electrode bodies 101 that constitute the electric storage element 105 are placed in such a way that, between a pair of adjoining electrode bodies 101, as shown in FIG. 2, the second principal face 151b adjoins the fourth principal face 161b. In addition, the number of electrode bodies 101 that constitute the electric storage element 105 is not limited to three; instead, there may be any number of electrode bodies so long as there are at least two.

The covering film 102 forms a housing space in which the electric storage element 105 and electrolyte are housed. The covering film 102 is a laminate film constituted by an aluminum foil or other metal foil laminated with a resin, where the film is fused and sealed around the electric storage element 105. Instead of the covering film 102, any can-shaped member, etc., that can seal the housing space may be used.

The electrolyte housed in the housing space together with the electric storage element 105 is not limited in any way, and a solution made with LiPF6 as a solute may be used, for example.

The positive-electrode terminal 103 is an external terminal of the positive electrodes 120, and it is electrically connected to the positive electrodes 120 in each electrode body 101. The positive-electrode terminal 103 is led out from between the covering films 102, to the outside of the housing space, as shown in FIG. 1. The positive-electrode terminal 103 may be a foil or wire made of a conductive material.

The negative-electrode terminal 104 is an external terminal of the negative electrodes 130, and it is electrically connected to the negative electrodes 130 in each electrode body 101. The negative-electrode terminal 104 is led out from between the covering films 102, to the outside of the housing space, as shown in FIG. 1. The negative-electrode terminal 104 may be a foil or wire made of a conductive material.

[Pre-Doping of Lithium Ions]

In the manufacturing stage of the electrochemical device 100, when the electric storage element 105 is immersed in the electrolyte in a state where the lithium collectors 151, 161 are electrically connected to the negative-electrode collectors 131, the metal lithium 152, 162 dissolves and lithium ions are released into the electrolyte. The lithium ions move through the electrolyte and are doped (pre-doped) into the negative-electrode active material layers 132 of the negative electrodes 130 provided in each electrode unit 111.

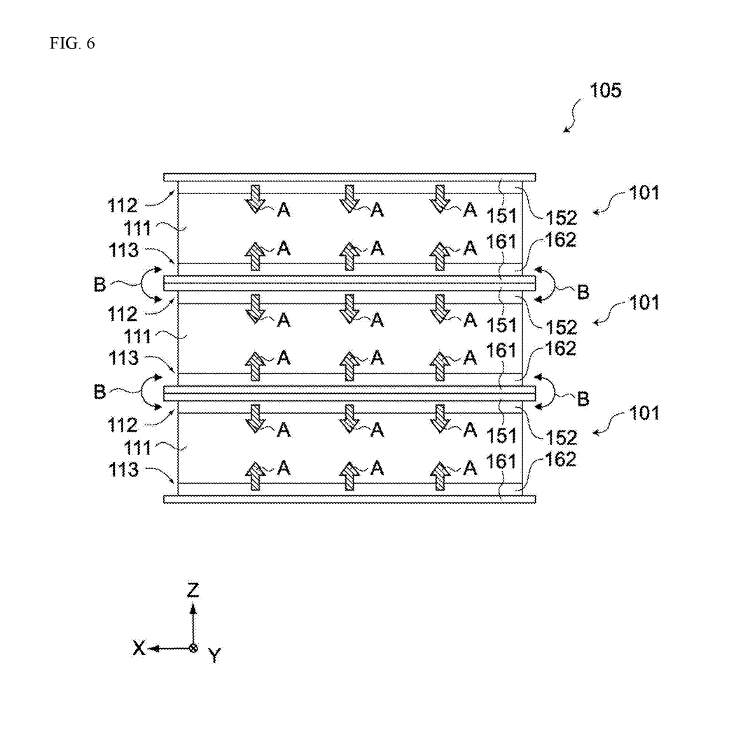

FIG. 6 is a schematic view showing how lithium ions are pre-doped. As shown in this figure, the lithium ions released from the metal lithium 152, 162 are doped into the electrode unit 111 positioned between each pair of the first lithium ion supply source 112 and the second lithium ion supply source 113 (arrows A in the figure).

Due to the placement of the metal lithium 152, 162 on the faces of the lithium collectors 151, 161 on the electrode unit 111 side (first principal face 151a and third principal face 161a), virtually the entire quantity of lithium ions is doped into the electrode units 111 within the same electrode body 101 in which the self-eluted lithium ion supply sources are provided.

On the other hand, while the lithium ions can also move to the adjoining electrode bodies 101 via the electrolyte (arrows B in the figure), they must go around the lithium collectors 151, 161, and therefore the quantity of lithium ions doped into the adjoining electrode bodies 101 becomes extremely small.

As described above, even when multiple electrode bodies 101 constitute one electric storage element 105, the lithium ions generated in a specific electrode body 101 are doped within the electrode units 111 provided in this specific electrode body 101, and hardly ever doped into the electrode units 111 provided in the adjoining electrode bodies 101. For this reason, the pre-doping quantity of lithium ions becomes uniform among the multiple electrode units 111, and consequently the long-term stability of the electrochemical device 100 can be ensured.

On the other hand, assume a constitution where the lithium ions generated in a specific electrode body 101 can easily move to other electrode bodies 101; in this case, the pre-doping quantity becomes non-uniform among the electrode bodies 101 due to, or the like, the effect of gravity associated with the installation direction of the electrochemical device 100, and its long-term stability drops as a result.

It should be noted that, as described above, the metal lithium 152, 162 dissolves during pre-doping and thus substantially no metal lithium 152, 162 remains by the time the electrochemical device 100 is used (i.e., after completion of pre-doping). However, an area where the metal lithium was placed before pre-doping shows traces of the presence of the metal lithium and thus is still detectable and discriminable based on composition analysis, similar to forensic analysis, of metal lithium residues, etc., present in the lithium collectors 151, 161.

### EXAMPLE

Metal lithium was attached on copper foils having no through holes, to produce lithium ion supply sources. The quantity of metal lithium was adjusted so that the SOC (state of charge) of negative electrodes would become approx. 60%.

Positive electrodes and negative electrodes were stacked together with separators in between, to produce an electrode unit as described above. The electrode unit was sandwiched between two lithium ion supply sources, to produce an electrode body as described above. Three such electrode bodies were stacked together, to which a positive-electrode terminal and a negative-electrode terminal were connected, and the assembly was sealed in a laminate film together with electrolyte. A lithium ion capacitor with a capacitance class of 2000 F was thus produced.

In addition, a lithium ion capacitor whose lithium ion supply sources were made by attaching metal lithium on copper foils having through holes, was produced for the purpose of comparison.

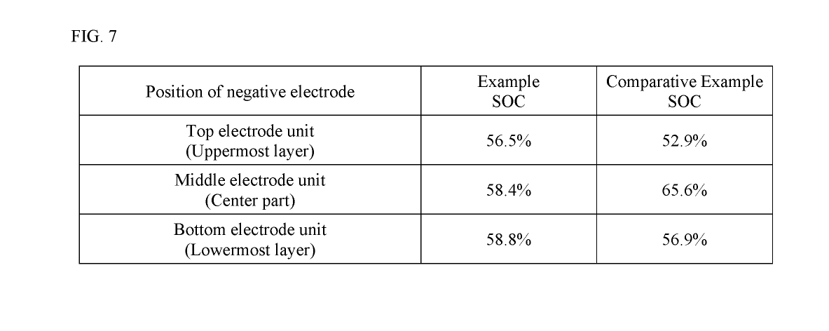

The lithium ion capacitors thus produced were compared in terms of the state of negative electrode pre-doping among the electrode bodies. FIG. 7 is a table showing the SOCs of the pre-doped negative electrodes that are located farthest away from the lithium ion supply source in the respective electrode units. It is evident from this table that, while lithium ions were doped roughly uniformly in the three electrode bodies in the example (the lithium collector had no through holes), the doping quantity varied widely in the comparative example (the lithium collectors had through holes).

This confirms that, according to the constitution pertaining to the aforementioned embodiment, the movement of lithium ions between the electrode bodies was suppressed by the lithium collectors, and consequently lithium ions were doped uniformly in each electrode body.

The foregoing explained an embodiment of the present invention; however, it goes without saying that the present invention is not limited to the aforementioned embodiment in any way, and that various changes can be added to it.

In the present disclosure where conditions and/or structures are not specified, a skilled artisan in the art can readily provide such conditions and/or structures, in view of the present disclosure, as a matter of routine experimentation. Also, in the present disclosure including the examples described above, any ranges applied in some embodiments may include or exclude the lower and/or upper endpoints, and any values of variables indicated may refer to precise values or approximate values and include equivalents, and may refer to average, median, representative, majority, etc. in some embodiments. Further, in this disclosure, “a” may refer to a species or a genus including multiple species, and “the invention” or “the present invention” may refer to at least one of the embodiments or aspects explicitly, necessarily, or inherently disclosed herein. The terms “constituted by” and “having” refer independently to “typically or broadly comprising”, “comprising”, “consisting essentially of”, or “consisting of” in some embodiments. In this disclosure, any defined meanings do not necessarily exclude ordinary and customary meanings in some embodiments.

The present application claims priority to Japanese Patent Application No. 2017-035431, filed Feb. 27, 2017, the disclosure of which is incorporated herein by reference in its entirety including any and all particular combinations of the features disclosed therein.

It will be understood by those of skill in the art that numerous and various modifications can be made without departing from the spirit of the present invention. Therefore, it should be clearly understood that the forms of the present invention are illustrative only and are not intended to limit the scope of the present invention.

We/I claim:

1. An electrochemical device constituted by:
(i) multiple electrode bodies wherein each electrode body comprises:
(a) an electrode unit constituted by positive electrodes and negative electrodes that are stacked together alternately with separators in between, and separators provided on principal faces of the electrode unit;
(b) a first lithium ion pre-doping supply source which is placed in a manner adjoining the electrode unit, and which comprises a first current collector being a metal foil which is electrolyte-impermeable and has a first principal face facing the electrode unit and a second principal face opposite to the first principal face; and
(c) a second lithium ion pre-doping supply source which is placed in a manner adjoining the electrode unit and sandwiching the electrode unit together with the first lithium ion pre-doping supply source, and which comprises a second current collector being a metal foil which is electrolyte-impermeable and has a third principal face facing the electrode unit and a fourth principal face opposite to the third principal face; and;
(ii) an electrolyte in which the multiple electrode bodies are immersed;
wherein:
the multiple electrode bodies are placed in a manner that, between a pair of adjacent electrode bodies, the second principal face of the first current collector of one of the adjacent electrode bodies adjoins the fourth principal face of the second current collector of the other of the adjacent electrode bodies; and
the negative electrodes provided in each electrode unit are pre-doped with lithium ions derived from a first metal lithium detectably attached on the first principal face of the first current collector of the first lithium ion pre-doping supply source, and also derived from a second metal lithium detectably attached on the third principal face of the second current collector of the second lithium ion pre-doping supply source.

2. The electrochemical device according to claim 1, wherein:
the positive electrodes provided in the electrode unit each comprise a positive-electrode collector being a porous metal film, as well as positive-electrode active material layers that contain a positive-electrode active material and are stacked on both a top face and a bottom face of the positive-electrode collector; and
the negative electrodes provided in the electrode unit each comprise a negative-electrode collector being a porous metal film, as well as negative-electrode active material layers that contain a negative-electrode active material and are stacked on both a top face and a bottom face of the negative-electrode collector.

3. The electrochemical device according to claim 1, wherein the electrode units provided in the multiple electrode bodies have the same thickness, respectively.

4. The electrochemical device according to claim 2, wherein the electrode units provided in the multiple electrode bodies have the same thickness, respectively.

5. The electrochemical device according to claim 1, which is a lithium ion capacitor.

6. The electrochemical device according to claim 2, wherein it is a lithium ion capacitor.

7. The electrochemical device according to claim 3, wherein it is a lithium ion capacitor.

8. The electrochemical device according to claim 4, wherein it is a lithium ion capacitor.
